(19) United States
(12) Patent Application Publication
(10) Pub. No.: US 2013/0144505 A1
(43) Pub. Date: Jun. 6, 2013

(54) METHOD FOR OPERATING AN EXHAUST GAS SYSTEM OF AN INTERNAL COMBUSTION ENGINE

(71) Applicant: Robert Bosch GmbH, Stuttgart (DE)

(72) Inventors: Joerg Neumann, Sindelfingen (DE); Torsten Handler, Stuttgart (DE); Hauke Wendt, Ditzingen (DE); Tobias Pfister, Stuttgart (DE)

(73) Assignee: ROBERT BOSCH GMBH, Stuttgart (DE)

(21) Appl. No.: 13/690,754

(22) Filed: Nov. 30, 2012

(30) Foreign Application Priority Data
Dec. 1, 2011 (DE) 10 2011 087 525.5

(51) Int. Cl. F02C 9/16

(52) U.S. Cl. CPC F02C 9/16
USPC 701/102; 60/274

(57) ABSTRACT

A method for operating an exhaust gas system of an internal combustion engine is described, wherein NOx is reduced by means of a SCR catalyst and a NOx reduction capability of an aqueous urea solution to be introduced into the exhaust gas system is monitored, and wherein at least one first variable characterizing the ammonia content of the water is ascertained and an ageing of the aqueous urea solution is inferred from said first variable.

### BACKGROUND OF THE INVENTION

The invention relates to a method for operating an exhaust gas system of an internal combustion engine.

Internal combustion engines, particularly diesel engines which reduce nitrogen oxides (NOx) present in the exhaust gas of the internal combustion engine by means of selective catalytic reduction (SCR), are known from the market. The NOx reduction takes place, for example, by means of ammonia (NH3) being introduced into the exhaust gas or respectively into the SCR catalyst. A patent publication from this subject area is, for example, DE 10 2009 029 107 A1.

### SUMMARY OF THE INVENTION

The invention has, among others, the advantage that an ageing of an aqueous urea solution for reducing nitrogen oxides in the exhaust gas of an internal combustion engine can be determined. A NOx reduction capability of the aqueous urea solution can especially be determined from a first variable characterizing the ammonia content in the water and a second variable characterizing the composition of said aqueous urea solution. Said second variable relates to a, if not the, essential variable characterizing the ageing. The aqueous urea solution can be optimally metered by means of the determined NOx reduction capability, and nitrogen oxides in the exhaust gas can be chemically broken down substantially independently of the quality and/or ageing of said aqueous solution. Components of a metering device and/or a feed device of the aqueous urea solution can furthermore be preventively protected against a chemical degradation.

The invention, in certain embodiments, relates to a method for operating an exhaust gas system of an internal combustion engine, wherein NOx (nitrogen oxides) are reduced by means of an SCR catalyst (“selective catalytic reduction”) and a NOx reduction capability of an aqueous urea solution to be introduced into the exhaust gas system is monitored (and therefore ascertained). The NOx reduction capability describes a reactivity of the aqueous urea solution to the reduction of NOx by means of the SCR catalyst. After being injected into the exhaust gas system, said aqueous urea solution releases ammonia (NH3) which is used in a known manner to chemically reduce nitrogen oxides. Said aqueous urea solution can deviate from specified properties for different reasons, whereby the reduction of nitrogen oxides in the SCR catalyst can be impaired. As the case may be, this can lead to the internal combustion engine—and therefore an associated motor vehicle—being shut down by an automatic switch-off after a certain time interval has elapsed. Besides an intentional manipulation on the part of the driver as, for example, an intentional dilution of the urea solution or an unintentional improper filling of a storage reservoir, the ageing of the aqueous urea solution can also be the reason for a decrease in the NOx reduction capability of the system. The ageing is characterized by a change in the composition of the aqueous urea solution and can happen relatively quickly, in particular in the case of high temperatures.

According to the invention, at least one first variable characterizing the ammonia content in the water is ascertained. The ageing of the aqueous urea solution (“solution”) can be inferred from the first variable which was ascertained. The ascertained variable is then used when monitoring the NOx reduction capability. The first variable characterizing the ammonia content in the water provides specific information with regard to the ageing of the solution. When the aqueous urea solution ages, the urea breaks down, wherein ammonia is formed, which can be easily dissolved in the surrounding aqueous solution. Ammonia dissolved in an aqueous solution has a reduction capability for the NOx reduction which is comparable to the ammonia bound in the urea. A certain amount of water as well as a certain amount of ammonia evaporates as a function of the properties of the storage reservoir in which the aqueous urea solution is stored. When said aqueous urea solution ages, the NOx reduction capability is then changed substantially as a function of the evaporation of the water and that of the released ammonia. The respective evaporation rates can vary and as the case may be are difficult to estimate or ascertain. Thanks to the method according to the invention, this no longer presents a problem.

The inventive method furthermore makes it possible for a metering system for metering and injecting the solution into the exhaust gas to be preventively protected. Ammonia reacts in a highly alkaline manner in the aqueous solution. With increasing ammonia content (NH3 concentration), the urea solution acts in a correspondingly aggressive manner on the components of the metering system. An ammonia content of 2 percent can, for example, represent a critical threshold value for possible damage to components. By determining the first variable characterizing the ammonia content, the driver of the motor vehicle can be warned and counter measures can be put into effect. In so doing, damage is avoided and costs are reduced.

Provision is further made in the method according to the invention for at least one second value characterizing the composition of the aqueous urea solution to be ascertained and for the NOx reduction capability of said aqueous urea solution to be inferred from the first and the second variable. The “composition” essentially means the concentration of urea in the solution, i.e. the proportion of urea in the total quantity, as well as an unknown proportion of ammonia which is dissolved in the water. The composition ascertained in this way is however non-specific with respect to the NOx reduction capability of the entire solution because the proportion of the ammonia dissolved in the water due to ageing cannot be detected or not correctly detected. By solely determining the second variable, a sufficiently precise result can thus only be delivered for solutions which have not aged. Without the additional information provided by the first variable, a supposedly insufficient quality for the purpose of NOx reduction could be detected in the case of a severe ageing of the aqueous urea solution. For that reason, the first variable, which characterizes the ammonia content in the water, and the second variable, which characterizes the composition of the aqueous urea solution, are thus ascertained. With both variables together, the NOx reduction capability of the aqueous urea solution, i.e. the quantity of ammonia effective for reducing NOx, can be inferred with a high degree of accuracy.

Provision is made in one embodiment of the invention for the first variable to be an electrical conductivity of the aqueous urea solution. As a result of the dissociation in the water, an equilibrium develops between the ammonia (NH3) and NH4+ ions formed in the water. Said ions have a comparatively high level of mobility and contribute accordingly to the conductivity of the solution. The proportion of the NH4+ ions is inferred from the conductivity which has been determined, and the proportion of ammonia (NH3) is inferred from said proportion of the NH4+ ions. The ageing of the aqueous urea solution is in turn inferred from said proportion of ammonia (NH3). The electrical conductivity therefore characterizes said ageing of the aqueous urea solution particularly well.

Provision is made in a further embodiment of the invention for the second variable to be a density and/or a refractive index and/or a sound velocity and/or a thermal conductivity and/or a dielectric permittivity of the aqueous urea solution. Previously known methods and elements can be used to determine the aforementioned values for the second variable, whereby costs can be saved.

Provision is furthermore made by the method for the ascertained first and second variable to be linked to one another by means of at least one characteristic diagram and/or a table and/or a mathematical formula in order to infer the NOx reduction capability of the aqueous urea solution. The NOx reduction capability can generally be expressed as:

R=f(c_NH3_urea+c_NH3), (1)
wherein
c_NH3_urea—NH3 concentration bound in urea;
c_NH3=NH3 concentration dissolved in an aqueous solution

The NOx reduction capability “R_new” without the influence of ageing can be specified in the following way:

R_new=f(c_NH3_urea_new), (2)
wherein
c_NH3_new=NH3 concentration bound in urea without ageing.

The ageing process can be specified in the following way:

c_NH3_urea=c_NH3_urea_new−f1(ageing), (3)
wherein
f1=function, which describes the change in the NH3 concentration bound in the urea due to ageing.

c_NH3=f2(ageing), (4)
wherein
f2=function, which describes the NH3 concentration dissolved in an aqueous solution as a result of ageing.

On account of the unknown evaporation, which is a function of the storage reservoir (“tank system”), the functions f1 and f2 or respectively the amounts thereof are generally not the same. For that reason, it can be stated:

f1□−f2, (5)
wherein the symbol “□” means “does not equal”.

A primary measurement of quality can be specified as follows:

Q_mess_prim=f(c_urea,c_NH3), (6)
wherein
Q_mess_prim corresponds to the density or the refractive index of the solution and thereby to the second variable;
c_urea=urea concentration of the solution.

The equation (6) is, for example, ascertained by means of the density or the refractive index of the aqueous urea solution and cannot selectively describe the NOx reduction capability of said aqueous urea solution. Additional options for a “concentration measurement”, which are mentioned here by way of example, include the sound velocity, the thermal conductivity or the dielectric permittivity. For example, an ageing of the aqueous urea solution falsifies the variable Q_mess_prim. The equation (6) alone is therefore only sufficiently exact for a solution that has not aged having c_NH3=0. In order to determine the amount of ageing, an ageing measured variable A_mess can be specified as follows:

A_mess=f(c_NH3), (7)
wherein
A_mess corresponds to the electrical conductivity of the solution and therefore to the first variable.

The ageing of the aqueous urea solution can be selectively ascertained using the equation (7). The NOx reduction capability which results in total can be specified as follows by means of the equations (6) and (7):

R=f(Q_mess_prim,A_mess) (8)

The NOx reduction capability of the aqueous urea solution can thereby be expressed as a two dimensional function of the primary measured variable Q_mess_prim according to equation (6) and the ageing measured variable A_mess according to equation 7.

The relationships formulated by means of the equations can preferably be described in an open-loop and/or closed-loop control device of an internal combustion engine or exhaust gas system by means of one or a plurality of characteristic diagrams, tables and/or mathematical formulas. The first and the second variable and consequentially the state or respectively the NOx reduction capability of the aqueous urea solution can thereby be particularly easily and exactly ascertained.

Provision is made in one embodiment of the method for a filling level of a reservoir of the reducing agent and/or a point in time of a filling of the reservoir and/or a temperature of the reducing agent to be used in order to ascertain the NOx reduction capability. In so doing, the accuracy in ascertaining the first and second variable can if necessary be improved or the result can be subjected to a plausibility check.

The invention is particularly useful if a quantity of the aqueous urea solution to be introduced into the exhaust gas system is ascertained as a function of the determined NOx reduction capability of said aqueous urea solution. Hence, the reduction of the nitrogen oxides resulting in the SCR catalyst can also then take place with a quantity of ammonia which is optimal in each case if the aqueous urea solution has already aged. In so doing, a pilot control for the metering of the aqueous urea solution can be manipulated such that a respectively changed NO reduction capability is compensated by a correspondingly adapted metered quantity. This facilitates using the aqueous urea solution over a comparatively large reactivity range without having to change the solution. Effort and expense can thereby be saved and the operation of the exhaust gas system will become more robust.

The method according to the invention can be particularly simply and cost effectively carried out by means of a computer program which, for example, can be executed in an open-loop and/or closed-loop control device for an internal combustion engine.

### BRIEF DESCRIPTION OF THE DRAWINGS

Exemplary embodiments of the invention are subsequently explained with reference to the drawings. In the drawings:

FIG. 1 shows a simplified illustration of an internal combustion engine and an exhaust gas system; and

FIG. 2 shows a flow diagram for ascertaining a NOx reduction capability of an aqueous urea solution.

### DETAILED DESCRIPTION

The same reference numerals are used in all of the figures for functionally equivalent elements and variables, even when the embodiments are different.

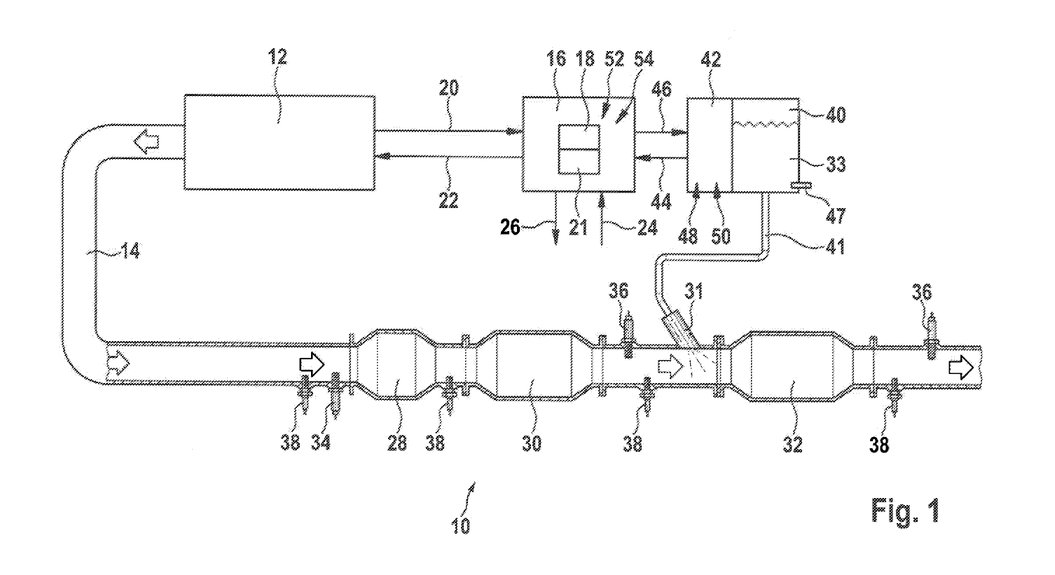

FIG. 1 shows a simplified diagram of an exhaust gas system 10 of a motor vehicle in the lower section of the drawing. An internal combustion engine 12 is symbolically depicted on the left above the exhaust gas system, said combustion engine discharging exhaust gas into the exhaust gas system 10 via a pipe connection 14. An open-loop and/or closed loop control device 16 is connected via incoming and outgoing electrical lines 20 and 22 to said combustion engine 12 as well as via incoming and outgoing electrical lines 24 and 26 to components of the exhaust gas system 10. The connections are merely indicated in the drawing. The open-loop and/or closed-loop control device 16 further comprises a computer program 18 and one or a plurality of characteristic diagrams 21. The computer program 18 can exchange data with the characteristic diagram 21.

The exhaust gas is substantially passed through the exhaust gas system 10 and processed therein from left to right. The present embodiment relates to the exhaust gas system of a diesel motor vehicle. In the direction of flow of the exhaust gas, said exhaust gas system 10 comprises therefore a diesel oxidation catalyst 28, a diesel particle filter 30, a feed device 31 for an aqueous urea solution 33 and a SCR catalyst (SCR meaning “selective catalytic reduction”).

A lambda probe 34 is disposed in the exhaust gas flow upstream of the diesel oxidation catalyst 28. A NOx sensor 36 is disposed in the exhaust gas flow in each case upstream and downstream of the SCR catalyst 32. In addition, the exhaust gas system 10 comprises four temperature sensors 38 in the present embodiment. The temperature sensors 38, the lambda probe 34 and the NOx sensors 36 are connected to the open-loop and/or closed loop control device 16 via the incoming and outgoing electrical lines 24 and 26. This is however not shown in detail in the drawing of FIG. 1.

A storage reservoir 40, which contains the aqueous urea solution and is connected to the feed device 31 via a hydraulic line 41, is disposed in the upper right region of the drawing of FIG. 1. A measuring device 42, which can ascertain physical variables of the aqueous urea solution 33, is depicted to the left of the storage reservoir 40. The measuring device 42 is electrically connected to the open-loop and or closed-loop control device 16 via electrical lines 44 and 46. A temperature sensor 47 ascertains the temperature of the aqueous urea solution 33 in the storage reservoir 40.

During the operation of the exhaust gas system 10, the aqueous urea solution 33 is injected in metered doses into said exhaust gas system 10 by means of the feed device 31. A reduction of the nitrogen oxides contained in the exhaust gas, which takes place in the SCR catalyst 32, is controlled and monitored by means of the NOx sensors 36 as well as by means of the temperature sensors 36. The measuring device 42 continuously or occasionally ascertains an electrical conductivity 48 and a density of the aqueous urea solution 33. Said measuring device 42 can alternatively ascertain a refractive index of said aqueous urea solution 33.

The electrical conductivity 48 obtained and the density 50 or respectively the refractive index obtained are transmitted to the open-loop and/or closed-loop 16 control device 16. The computer program 18 determines a first variable 52, which characterizes the ammonia content (NH3 content) in the water of the aqueous urea solution 33, from the electrical conductivity 48. In addition, the computer program 18 determines a second variable 54, which characterizes the composition of said aqueous urea solution 33, from the density 50. In a complementary manner, the determination of the first and second variable 52 and 54 can take place while taking into account the temperature of said aqueous solution 33 provided by the temperature sensor 47.

A NOx reduction capability is subsequently inferred from the first variable 52 and the second variable 54. For that purpose, the characteristic diagram 21 comprises on the one hand functional relationships between the first and second variable 52 and 54 and on the other hand the functional relationship for the NOx reduction capability. Said functional relationship for the NOx reduction capability is generally expressed as a function of the respective concentrations:

R=f[f(c_urea,c_NH3), f(c_NH3)],
wherein
c_urea=concentration of urea
c_NH3=NH3 concentration dissolved in an aqueous solution

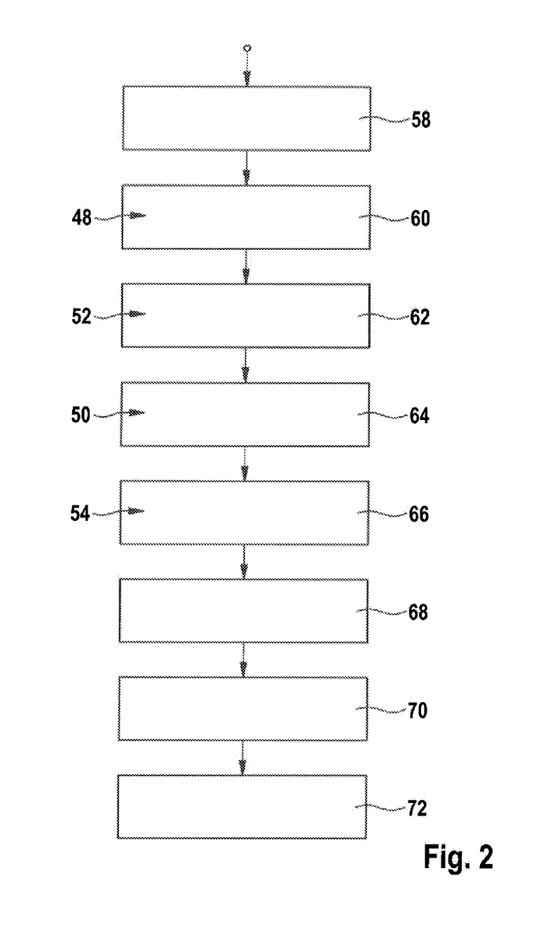

FIG. 2 shows a flow diagram for operating the exhaust gas system 10 of the internal combustion engine 12. The NOx reduction capability and the corrected metered quantities of the aqueous urea solution 33 ensuing therefrom are especially ascertained. The procedure depicted in FIG. 2 begins in a starting block 58.

The electrical conductivity 48 of the aqueous urea solution 33 is ascertained in a first block 60. In a subsequent block 62 the first variable 52, which characterizes the ammonia content of the water, is ascertained from the electrical conductivity 48.

In a further block 64, the density 50 of the aqueous urea solution 33 is ascertained. In a subsequent block 66, the second value, which characterizes the composition of the aqueous solution 33, is ascertained from the density 50.

In a further block 68, the temperature of the aqueous urea solution 33 is ascertained. In a complementary manner, a filling level and/or a point in time of the last filling of the storage reservoir 40 can be ascertained and used to determine the plausibility of the succeeding operations. The temperature and the first as well as the second variable 52 and 54 are linked to one another by means of the characteristic diagram 21 and through the use of mathematical formulas, and a measurement for the NOx reduction capability of the aqueous urea solution 33 is ascertained therefrom. If said NOx reduction capability is less than a predeterminable threshold value, an error bit can be placed in a supplementary manner in a diagnostic memory and/or an item of information can appear on the dashboard of the motor vehicle.

In a further block 70, a metered quantity of the aqueous urea solution 33 is ascertained as a function of the previously obtained measurement of the NOx reduction capability. Said metered quantity can be used during the operation of the exhaust gas system 10 to inject a corresponding quantity of said aqueous urea solution 33 via the feed device 31 into said exhaust gas system 10. The metering of the aqueous urea solution 33 can thereby be optimized in accordance with the NOx reduction capability ascertained; and therefore neither too small of nor too large of a quantity of ammonia is supplied to the SCR catalyst 32. In a succeeding end block 72, the procedure depicted in FIG. 2 ends.

1. A method for operating an exhaust gas system of an internal combustion engine, wherein NOx is reduced by means of a SCR catalyst and a NOx reduction capability of an aqueous urea solution to be introduced into the exhaust gas system is monitored, the method comprising:
ascertaining at least one first variable characterizing the ammonia content of the water; and
monitoring the NOx reduction capability of the aqueous urea solution.

2. The method according to claim 1, wherein at least one second variable characterizing the composition of the aqueous urea solution is ascertained and the NOx reduction capability of said aqueous urea solution is inferred from the first and the second variable.

3. The method according to claim 1, wherein the first variable is an electrical conductivity of the aqueous urea solution.

4. The method according to claim 1, wherein the second variable is a density and/or a refractive index and/or a sound velocity and/or a thermal conductivity and/or a dielectric permittivity of the aqueous urea solution.

5. The method according to claim 1, wherein the ascertained first and second variables are linked to one another by means of at least one characteristic diagram and/or a table and/or a mathematical formula in order to infer the NOx reduction capability of the aqueous urea solution.

6. The method according to claim 1, wherein a filling level of a reservoir of the reducing agent and/or a point in time of a filling of the reservoir and/or a temperature of the reducing agent are used in a complementary manner for ascertaining the NOx reduction capability.

7. The method according to claim 1, wherein a quantity of the aqueous urea solution to be introduced into the exhaust gas system is ascertained as a function of the NOx reduction capability ascertained for said aqueous urea solution.

8. A computer program stored on a non-transitory computer readable media, wherein said program is programmed for carrying out a method according to claim 1.

9. An open-loop and/or closed loop control device for an internal combustion engine wherein a computer program according to claim 8 can be executed therein.
